(19) United States
(12) Patent Application Publication
(10) Pub. No.: US 2006/0106881 A1
(43) Pub. Date: May 18, 2006

(54) System and method for global data synchronization

(75) Inventors: Paul C.P. Leung, Vancouver (CA); Michael Kuan-Hung Chang, Delta (CA); Kenneth Kee Ho, Coquitlam (CA); Kyle Tegan MacDonald, Coquitlam (CA)

Correspondence Address: BLACK LOWE & GRAHAM, PLLC, 701 FIFTH AVENUE, SUITE 4800, SEATTLE, WA, 98104, US

(73) Assignee: Empower Technologies

(21) Appl. No.: 11/258,723

(22) Filed: Oct. 25, 2005

Related U.S. Application Data
(60) Provisional application No. 60/622,044, filed on Oct. 25, 2004.

(51) Int. Cl. G06F 17/30

(52) U.S. Cl. 707/200

(57) ABSTRACT

A system and method is disclosed for synchronizing data between two or more devices connected to each other by a network. The devices execute instances of substantially identical applications storing data. A synchronization module executes on each of the devices. The synchronization module may monitor access to the databases and maintain a synchronization database of the changes to the databases. The synchronization databases of the devices are then synchronized. Conflicting changes to the database are resolved according to default protocols and user configured protocols. Conflict resolution protocols may be transmitted between devices prior to resolving conflicts.

### PRIORITY CLAIM

This application claims the benefit of Provisional Patent Application Ser. No. 60/622,044 filed Oct. 25, 2004.

### FIELD OF THE INVENTION

This invention relates generally to portable digital assistants, and, more particularly to systems of method for synchronizing databases stored on portable digital assistants.

### BACKGROUND OF THE INVENTION

In the past few years, Internet access has became more ubiquitous and affordable. Customers can access Internet from their office, home, hotel and many public places such as libraries and cafés. Also, wireless networks have matured. GPRS networks are available in major cities at reasonable prices. Accessing the Internet through wireless access points, GPRS mobile devices, and the like, provides users freedom to access information anywhere and anytime.

Personal electronic devices have also become more popular and more powerful. Cell phones, PDAs, notebooks and other portable devices and smart electronics such as portable music players make information and computing power available essentially everywhere at any time. Such devices are often used to execute personal information management (PIM) software that manages such information as contacts, memos, calendars and event scheduling. Other data handled by such devices may include photo albums, audio and video play lists and content, documents, presentations, spreadsheets, etc. Large amounts of data important to users may be stored both on a desktop computer and a portable device. Synchronization of such data is the process where each storing device, such as a PDA and desktop computer, can exchange the personal information stored on each to make a large “synchronized” database of information containing the same PIM data on each system.

In prior systems, synchronization involved the PDA and a desktop computer. In such systems, the entire database is transferred to one device, which transfers back an updated database. Such systems provide the singular disadvantage of requiring a large amount of data transfer capacity and time in order to achieve synchronization regardless of the extent of changes to the database.

Prior systems are also limited to synchronization between one PDA and one computer. They provide no means for coordinating synchronization between a PDA and multiple other computers or other devices. A typical person may have a home computer, a work computer, and a laptop computer. A typical person may also use various other computers to access the Internet. Accordingly, confusion and loss of data may result from a user attempting to synchronize each of these computers separately.

Some prior systems synchronize database, such as PIM databases between desktop computers. However, such systems synchronize by transferring the entire database between computers. Such systems do not provide a means for a additions, modifications and deletions made on multiple instances of the database to be coordinated without loss of data due to overwriting of one instance of the database with another.

In view of the foregoing it would be an advancement in the art to provide a synchronization system coordinating synchronization of information stored on distinct and potentially multiple databases. Such a system would reduce network bandwidth required for synchronization and avoid the loss of data.

### SUMMARY OF THE INVENTION

The present invention includes a system including two or more devices connected to each other via a network. The devices may include a PDA, workstation or notebook computer, server, smart phone, or the like. The devices execute instances of substantially identical applications storing data, such as PIM data, in databases. A first device, for example a server, stores a database that is maintained in synchronization with the databases stored on the device. The devices may also synchronize their respective databases with one another.

A synchronization module may execute on each of the devices. The synchronization module may monitor access to the databases and maintain a synchronization database of the changes to the databases. The synchronization databases of the devices are then synchronized to provide updated databases each device. In one embodiment, a first device may synchronize with a second device. The first or second device may then synchronize with a third device, such as a server. The first and second device may then synchronize again such that all three components of the system store an identical database.

The databases may store records, with each record stored in a database on one device corresponding to another record stored in a database on another device. The synchronization module may identify instances where corresponding records are changed and resolve conflicts. In one embodiment, one of the records is assigned a higher priority than the other and the changes in the higher priority record are incorporated into the synchronized databases.

Priority may be established by default protocols stored by the synchronization module. In certain embodiments, default protocols are preempted by user input protocols for resolving conflicts. A user may specify that priority among conflicting records is to be decided based on which record was changed last, the identity of the user who made the change, the device on which the record was changed, and the like. In some embodiments, priority is determined based on a user input received at the time of synchronization indicating which individual record, or data within records, has priority over a corresponding record. In one embodiment, user protocols for resolving conflicts are transmitted between the devices prior to resolving conflicts to establish a shared standard for resolving conflicts.

Transmittal of some data within the databases may be restricted due to concerns of security, copyright laws, or the like. In one embodiment, the synchronization module refrains from transmitting data subject to restrictions. In some instances, restrictions may be embodied as a limitation on the number of times that data may be transferred through synchronization. Metadata relating to restricted data may nonetheless be synchronized during the synchronization process described above.

As will be readily appreciated from the foregoing summary, the invention provides an efficient manner to synchronize databases across multiple devices. The invention also provides predictable means for resolving conflicting changes to the database and to allow user configurable resolution of conflicts.

### BRIEF DESCRIPTION OF THE DRAWINGS

Preferred and alternative embodiments of the present invention are described in detail below with reference to the following drawings.

FIG. 1 is a schematic view of a networked configuration of computing devices suitable for use in an embodiment of the present invention;

FIG. 2 is schematic block diagram of components of a synchronization system, in accordance with an embodiment of the present invention;

FIG. 3 is a schematic block diagram indicating the flow of data, in accordance with an embodiment of the present invention;

FIG. 4A is a process flow diagram of a method for synchronizing a PDA, workstation, and server, in accordance with an embodiment of the present invention;

FIG. 4B, is a process flow diagram of a workstation initiated synchronization method, in accordance with an embodiment of the present invention; and

FIGS. 5A-5D are process flow diagrams illustrating synchronization steps, in accordance with an embodiment of the present invention.

### DETAILED DESCRIPTION OF THE PREFERRED EMBODIMENT

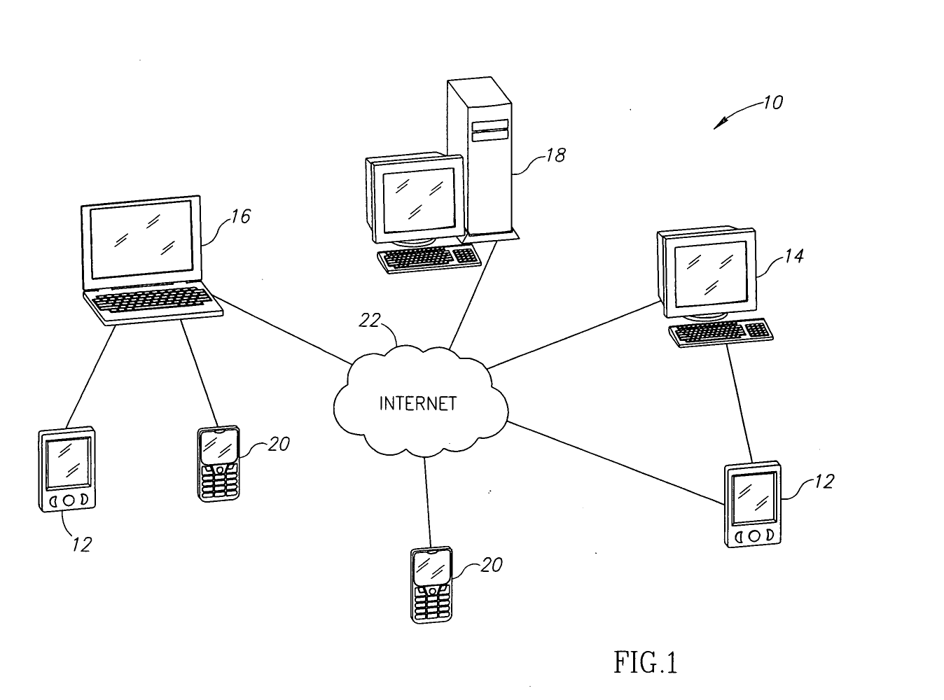

Referring to FIG. 1, in one embodiment of the present invention a synchronization system 10 includes a portable digital assistant (PDA) 12, a workstation 14, a remote workstation 16, and a server 18. In some embodiments, one or more smart phones 20 may also connect to the workstation 14, server 18, or PDA 12. The particular devices described herein are examples only of the types of devices that may be used with the present invention, which may include a wide variety of stationary or portable computing devices. The PDA 12, workstations 14, remote workstation 16, server 18, and smart phones 20a, 20b may each include a central processing unit CPU capable of executing programmed instructions and operational memory or RAM operably connected to the CPU and capable of storing programmed instructions and other data. The PDA 12, workstations 14 and remote workstation 16 may further include nonvolatile secondary storage such as a hard drive, flash memory, or the like. The PDA 12, workstations 14 and remote workstation 16 may connect to the server 18 by means of a network 22, such as the Internet. The PDA 12 may additionally connect directly to the workstation 14 or remote workstation 16.

The PDA 12, workstation 14, remote workstation 16, and server 18 may connect to the network 22 by means of cables such as Ethernet cables, fiber optic cables, or the like. Alternatively, the components of the system 10 may connect by means of wireless devices based on networking protocols such as IEEE 802.11b or 802.11g, general packet radio service (GPRS), Bluetooth, and the like.

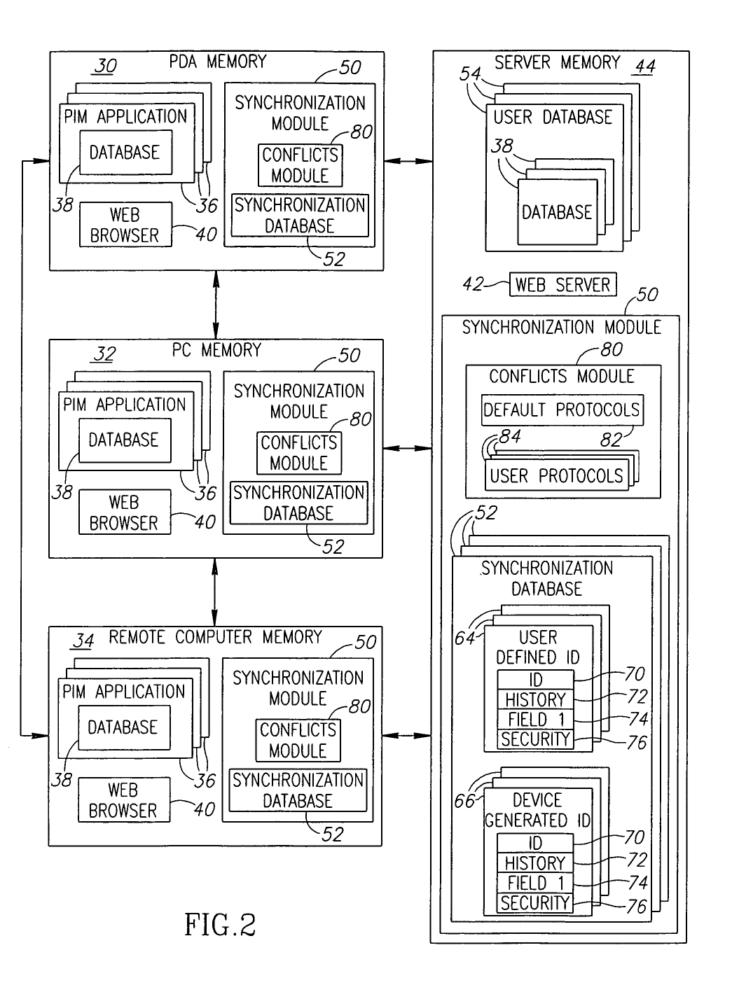

Referring to FIG. 2, while still referring to FIG. 1, the memory 30 of the PDA 12, memory 32 of the workstations 14, and memory 34 of remote workstation 16 may store one or more information management applications, such as personal information management (PIM) applications 36. The PIM applications 36 may include PIM databases 38 storing PIM information. In some embodiments, the PIM applications 36 may be substantially identical in the sense that they create, display, and store records of a substantially identical format such that a record created by one PIM application 36 can be read or reproduced by another application 36. The applications 36 may vary in underlying object code and low level logic and still be identical as contemplated by the invention. It will be noted that the disclosed invention is particularly useful in the PIM context. However, other applications and their associated databases may be advantageously synchronized with the invention disclosed herein.

The memories 32, 34, 36 may also store a web browser 40 for interacting with a webs server 42 stored in server memory 44. A smart phone 20 may likewise store a PIM application 36 and a browser 40.

The PDA 12, workstation 14, remote workstation 16, server 18, and smart phone 20, may store a synchronization module 50 having a synchronization database 52. The synchronization module 50 may monitor changes to the PIM databases 38 and coordinate synchronization of the PIM databases 38 stored on the PDA 12, workstation 14, remote workstation 16, server 18, and smart phone 20. The server 18 may store copies of PIM databases 38 within user databases 54. Accordingly, an individual user may synchronize PIM databases 38 on a PDA 12, workstation 14, remote workstation 16, and smart phone 20 with the server 18 via the network 22.

The server 18 may host a web server 42 providing a browser-based interface to the synchronization module 50 thereof and the user databases 54 stored thereon. The web server 42 may provide a website giving users an interface to the user database 50 such that users can create, modify, delete, or view data, including PIM information such as contact information, calendars, events, memos, tasks, expense records, digital photographs, digital music, email, web content, and the like. Users may access the server 18 by means of a browser 40. The browser 40 may cooperate with the synchronization module 50 of the PDA 12, workstation 14, remote workstation 16, and smart phone 20 to receive updates from the server 18 into the local synchronization database 50.

The web server 42 provides ports for the devices comprising the system 10 to connect to the server 18. The synchronization module 50 of the server 18 may monitor the ports to detect when another device attempts to connect to the server 18. In some embodiments, the server 18 does not initiate synchronization. However, in other embodiments, a user may direct the server 18 to initiate synchronization with another device.

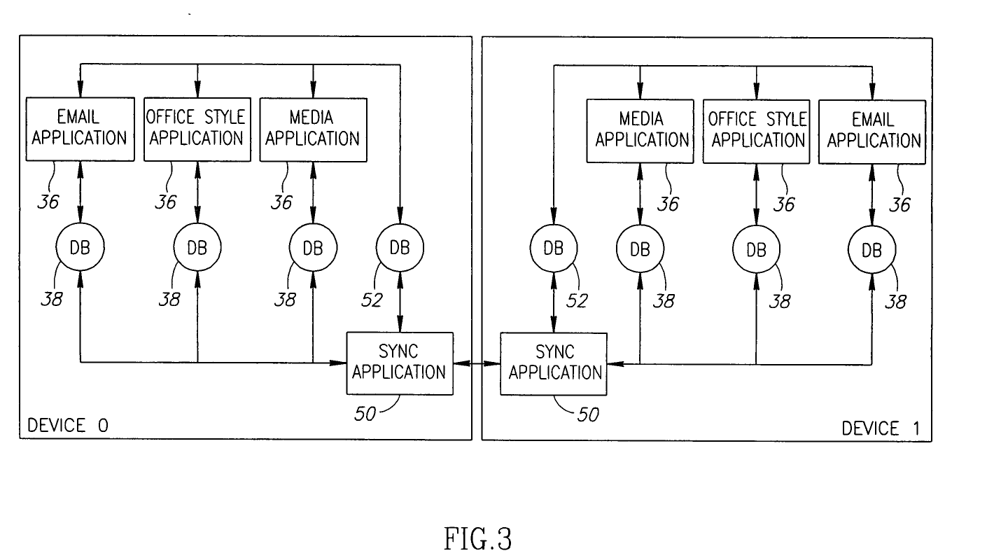

With further reference to FIG. 3, in one embodiment the synchronization module monitors the activities of the PIM applications 36 relating to the PIM databases 38 and updates the synchronization database 52 to indicate such information as which records were modified, added or deleted; the time of a modification, addition, or deletion; the field within a particular record that was deleted; and the like.

The synchronization modules 50 of the devices constituting the system 10, such as the PDA 12 and PC 16 may then synchronize their respective synchronization databases 52. The synchronization module 50 may also interface with the PIM applications 36 to modify the PIM databases 38 to reflect changes occurring on a second device. On the server 18, the synchronization module 50 updates the PIM databases 38 within the user databases 52. In some embodiments, the synchronization modules 50 of the PDA 12, workstation 14, remote workstation 16, server 18, and smart phone 20 directly access the PIM databases 38 to reflect changes received from another device.

Referring again to FIGS. 1 and 2, a synchronization database 52 may classify records stored therein as user-defined identifier records 64 and device-generated identifier records 66. The records 64, 66 may contain such information as a unique identifier 70, history 72, and data fields 74.

The identifier 70 may be a unique number or other data assigned to the record 64, 66. Alternatively, the identifier 70 may be data stored within the record 64, 66 that characterizes the record 64, 66. For example, a record 64, 66 relating to contact information such as addresses and phone numbers may be characterized by the name of the contact.

The history 72 may indicate which fields 74 were changed; whether the change was a modification, addition, or deletion; the time a change occurred; the device on which the change was originally made; the identity of an intervening device through which the change was transferred from the originating device to the device hosting the synchronization database 50; the identity of the user who caused the change; or the like. The fields 74 may contain the actual data stored within the record 64, 66. In one embodiment of the invention, only data within fields 74 that have been changed is stored in the synchronization module and transferred during the synchronization process. In other embodiments, the fields 74 identify data within the PIM databases 38 has been changed, but do not store the actual data. In one embodiment, the synchronization module is integrated with the user databases 54. Accordingly, a history 70 may be stored with each record within the user databases 54. The synchronization module 50 may then evaluate which records 64, 66 within the database 26 have been added, modified, or deleted when synchronizing by reviewing the histories 70. The synchronization database may reduce the amount of network capacity required to synchronize databases by requiring only changed data to be sent, rather than the entire database.

In some embodiments, records 64, 66 include security data 76. Security data may be used by the synchronization module 50 to restrict content from synchronization to different parties or devices. This functionality may be helpful in instances where a person or group wishes to restrict sensitive information to a limited number of devices or type of devices. For example, a user may not wish to have all personal contacts from a home computer synchronized with an office computer. Security data 76 may further enable protection against copying of copyrighted or licensed material. Some content providers may want to restrict the amount of copying through synchronizing. For example, a user may wish to synchronize play lists between multiple devices, and copy the music or videos contained in the playlists. However, some of that content may have restrictions limiting the number of copies that may be made. Accordingly, a synchronization module 50 may record in the history 72 the number of devices synchronized to contain data having security data 76 indicating restrictions. When synchronizing, the synchronization module 50 may then refrain from transferring such data to devices prohibited by copyright laws or license agreements. In some embodiments, metadata, such as an identifier, outline of content, or playlists, relating to restricted content is synchronized with other devices whereas the content is not.

User-defined identifier records 64 may be embodied as records which the user has indicated shall be the designated storage location of data belonging to a particular classification of data. Device-generated identifier records 66 may be embodied as information stored on a system but which has not been designated as belonging to a particular classification of data.

For example, PIM software may store information relating to a particular person such as phone number, address, and the like. A record containing this information and embodied as a user-defined identifier record 36 may serve as the location for storing the phone number, address, and the like for that person. Thus, if during operation a user attempts to enter a phone number corresponding to the person's name or another identifier associated with the record, the phone number in the record for that user will be changed. On the other hand, if the record were embodied as a device-generated identifier record 38, then entering a phone number and the person's name would result in creation of a separate record having a unique device generated identifier.

Deleted records 64, 66 may be stored in the synchronization database 52 until synchronization occurs or be represented by a record 64, 66 indicating the identifier 68 of the deleted record and the fact that the record 64, 66 has been deleted.

The synchronization module 50 may further include a conflicts module 80. A conflicts module 80 may resolve conflicts between additions, deletions, and modifications of the same data originating from different components of the system 10. The conflicts module 80 may resolve conflicts according to default protocols 82. However, the synchronization module 50 may preempt default protocols according to user protocols 84 for resolving conflicts. In one embodiment of the invention the default protocols 82 resolve conflicts according to Table 1.

TABLE 1
Conflict Resolution Protocols

| | | Final state of record after Synchronization | |
|---|---|---|---|
| Actions | | User Defined | Device Generated |
| Party 1 | Party 2 | Unique Identification | Unique Identification |
| ADD | ADD | One instance of the | One instance of each |
| | | same record is on | record is on both |
| | | both devices. | devices. |
| ADD | MODIFY | Scenario N/A | Scenario N/A |
| ADD | DELETE | Scenario N/A | Scenario N/A |
| ADD | NONE | One instance of the | One instance of the |
| | | same record is on | same record is on |
| | | both devices. | both devices. |
| MODIFY | ADD | Scenario N/A | Scenario N/A |
| MODIFY | MODIFY | If the same field in | If the same field |
| | | each record is | in each record is |
| | | modified, the data | modified, the data |
| | | in that field will | in that field will |
| | | be as Party 1. | be as Party 1. |
| | | Otherwise merged. | Otherwise merged. |
| MODIFY | DELETE | Modified data is | Modified data is |
| | | reflected in both | reflected in both |
| | | databases. | databases. |
| MODIFY | NONE | Modified data is | Modified data is |
| | | reflected in both | reflected in both |
| | | databases. | databases. |
| DELETE | ADD | Scenario N/A | Scenario N/A |
| DELETE | MODIFY | Record Deleted | Record Deleted |
| DELETE | DELETE | Record Deleted | Record Deleted |
| DELETE | NONE | Record Deleted | Record Deleted |
| NONE | ADD | One instance of the | One instance of the |
| | | same record is on | same record is on |
| | | both devices. | both devices. |
| NONE | MODIFY | Modified data is | Modified data is |
| | | reflected in both | reflected in both |
| | | databases. | databases. |
| NONE | DELETE | Record Deleted | Record Deleted |
| NONE | NONE | No change, both | No change, both |
| | | records are the | records are the |
| | | same | same |

Table 1 summarizes conflict resolution for protocols where multiple parties attempt to modify a database of information, such as PIM information. Multiple parties may include distinct individuals accessing a particular user database 54 on the server 18, or the same individual accessing the user database 54 on the server 18 from different devices. In the illustrated embodiment, Party 1 and Party 2 have different priorities. Priority may be defined based on the identity of the individual. However, in one embodiment of the invention, priority is according to the device constituting the system 10 from which the user accesses the database 26 on the server 18. In other embodiments, priority is based on the time a change was made. Priority may also be user configurable. In some embodiments, a user may configure the conflicts module 80 to notify the user of conflicts and receive user input as to which of two conflicting changes will become part of the database 54. In such embodiments, the conflicts module 80 when notifying the user of conflicting changes may indicate which of the conflicting changes has priority according to a default protocol 82, user defined protocol, or both.

In one embodiment of the invention, user protocols stored within the synchronization modules 50 may be passed between synchronizing devices prior to synchronization of their respective synchronization databases 52. Such as step may be useful to ensure that all parties contain the same rules for conflict arbitration. Some embodiments may further include default protocols 82 and user protocols 84 associated with individual records or individual fields within records. Such protocols may be transferred between devices prior to synchronization of the record or field within the record. Default protocols 82 and user protocols 84 may contain universal default or user configurable rules for determining the default protocols 82 and user protocols 84 of which device will control resolution of conflicts.

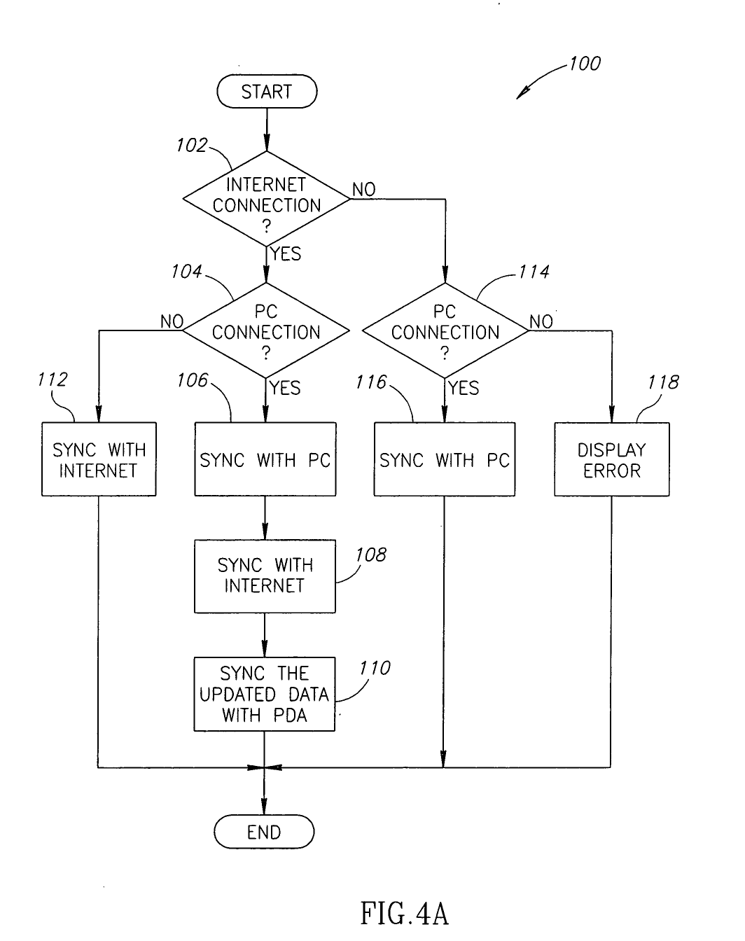

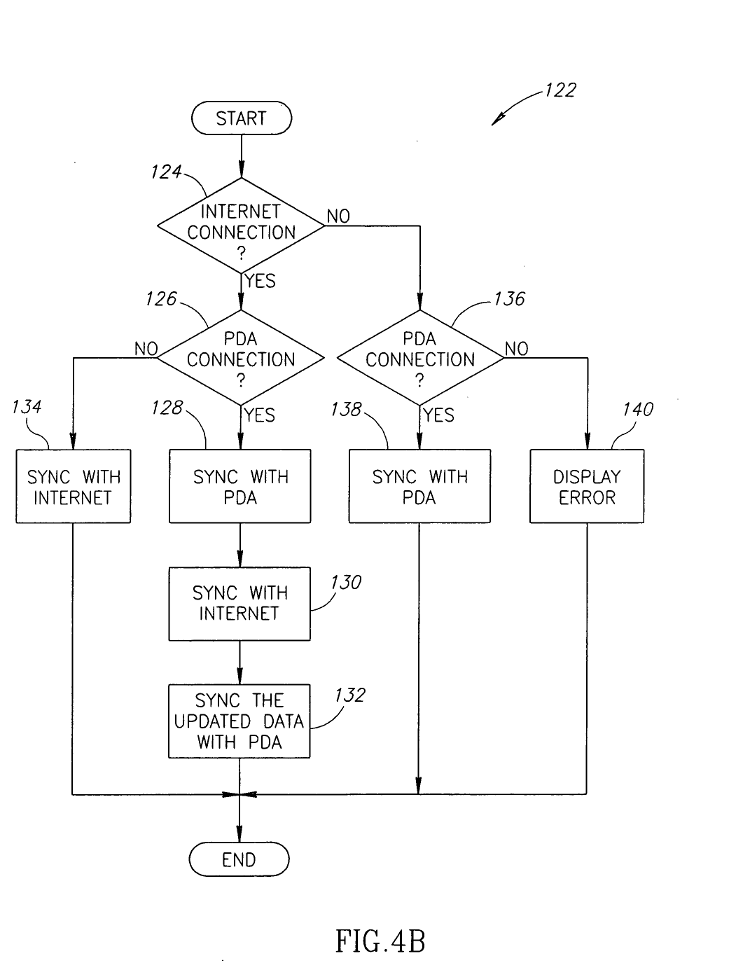

Referring to FIG. 4A, in one embodiment of the invention, the system 10 executes a method 100 for synchronizing a PDA 12, workstation 14, and server 18 over a network 22. The method 100 may be executed by a PDA 12, workstation 14, and server 18 connected as illustrated in FIG. 1. In one embodiment of the method 100, the PDA 12 may evaluate 102 whether it is connected or connectible with the server 18 via the network 22. If so, the PDA 12 may then evaluate 104 whether it is connected to the workstation 14. If so, the PDA 12 synchronizes 106 with the workstation 14 as described above, including synchronizing respective synchronization databases 50 and resolving conflicts according to the operation of the conflicts module 80. The method 100 may then include synchronizing 108 the PDA 12 with the server 18 via the network 22 in a like manner. The PDA 12 may then be synchronized 110 again with the workstation 14 to transfer any updates from the server 18 to the workstation 14. If a workstation connection is not found in step 104, then the PDA 12 may be synchronized 112 with the server 18 via the network 22. The precise sequence of the synchronization steps may vary depending on factors including system efficiencies, user preference or device availability. For example, steps 106 through 110 may alter in sequence. In an alternative embodiment synchronization of one or more devices may also occur simultaneously or in parallel.

If a connection to the server 18 is not found in step 102, the method 100 may include evaluating 114 whether the PDA 12 is connected to the workstation 14. If so, then the PDA 12 is synchronized 116. If not, then an error is displayed 118 on the PDA 12, workstation 14, or both.

Referring to FIG. 4B, a system 10 may execute a method 122 for synchronizing a workstation 14 with a PDA 12 where the workstation 14 initiates synchronization. The method 122 may include evaluating 124 whether the workstation 14 is connected to the server 18 by means of the network 22. If so, the method 122 may include evaluating 126 whether a connection to the PDA 12 is present. If so, the PDA is synchronized 128 with the PDA and synchronized 130 with the server 18. The updated workstation 14 is then synchronized 132 with the PDA 12. If a connection with the PDA 12 is not found at step 126, then the workstation 14 is synchronized 134 with the server 18. The precise sequence of the synchronization steps may vary depending on factors including system efficiencies, user preference or device availability. For example, steps 128 through 132 may alter in sequence. In an alternative embodiment synchronization of one or more devices may also occur simultaneously or in parallel.

If a connection to the server 18 is not found in step 124, the method 100 may include evaluating 136 whether a connection with the PDA 12 is found. If so, then the workstation 14 is synchronized 138 with the PDA 12. If a connection to server 18 or PDA 12 is not found, then an error message is displayed 140 on the PDA 12, workstation 14, or both.

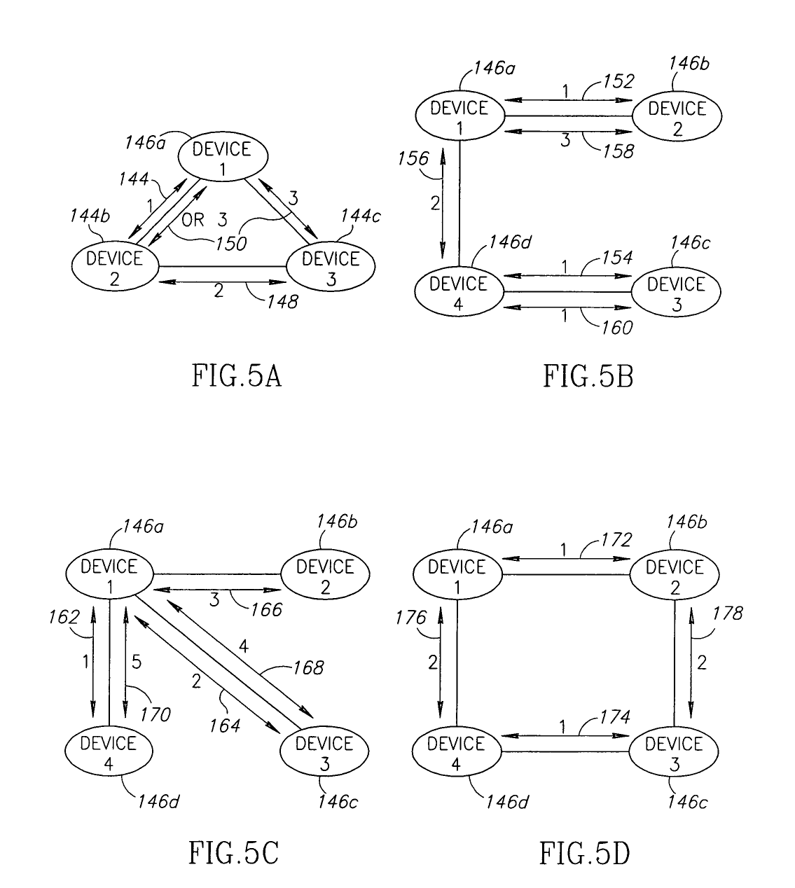

Referring to FIGS. 5A-5D, as described above, various orderings of synchronizations between the devices forming the system 10 are contemplated by the invention. The methods 100 and 122 may be represented as illustrated in FIG. 5A. Step 144 includes synchronizing device 146a with device 146b. Step 148 includes synchronizing device 146b and 146c. Step 150 may include either synchronizing device 146c with device 146a or again synchronizing device 146b with device 146a, such that all three devices 146a-146c are synchronized with one another. The device 146c, 146b used in step 150 may be chosen based on which offers the fastest connection speed connecting the device 146c, 146b to device 146a

Where more than three devices are synchronizing, the process of synchronization may be as in the flow charts of FIGS. 5B-5D. In the embodiment of FIG. 5B, device 146a is synchronized 152 with device 146b. Device 146c is synchronized 154 with device 146d. Synchronizations 152, 154 may take place simultaneously or both take place prior to synchronization 156 of device 146d with device 146a. After synchronization 156, devices 146a and 146b are again synchronized 158 and devices 146c and 146d are again synchronized 160.

In the embodiment of FIG. 5C, devices 146a and 146d are synchronized 162, followed by synchronization 164 of devices 146a and 146c. Devices 146a and 146b are then synchronized 166, followed by re-synchronizing 168 Devices 146c and 146a and then re-synchronizing 170 devices 146a and 146d.

In the embodiment of FIG. 5D, devices 146a and 146b are synchronized 172 and devices 146c and 146d are synchronized 174. Steps 172 and 174 may be substantially simultaneous inasmuch as they do not involve a common device. Devices 146a and 146d are then synchronized 176 and devices 146b and 146c are synchronized 178. Steps 176 and 178 may be executed substantially simultaneously inasmuch as they do not involve a common device.

These orderings of FIGS. 5B and 5D may serve to reduce the amount of peer-to-peer synchronizations to two or three as illustrated. After each synchronization step, the devices contain information of all the previously synchronized devices from both devices, allowing for the ordering of FIG. 5D to have only two synchronization

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method for synchronizing data, the method comprising:
providing a first computing device storing a first application instance and a first database storing data accessed by the first instance of the application, the first computing device being portable;
providing a second computing device storing a second application instance and a second database storing data accessed by the second instance of the application;
providing a third computing device storing a third database;
providing a network connecting the first, second, and third computing devices;
monitoring access by the first application instance to the first database;
recording changes to the first database in a first synchronization database;
monitoring access by the second application instance to the second database;
recording changes to the workstation database in a second synchronization database; and
synchronizing the first, second, and third databases according to the first and second synchronization databases.

2. The method of claim 1, wherein synchronizing the first, second, and third databases comprises first synchronizing the first synchronization database and second synchronization database; second synchronizing at least one of the first and second synchronization databases with a third synchronization database stored on the third computing device; and third synchronizing the first synchronization database and second synchronization database;

3. The method of claim 2, wherein the first synchronization database contains records having first identifiers and wherein the second and third synchronization databases each store records having second and third identifiers, respectively, each corresponding to one of the first identifiers, and wherein synchronizing the first, second, and third synchronization databases comprises synchronizing records in the first, second, and third synchronization databases having identical first, second, and third identifiers.

4. The method of claim 3, wherein synchronizing records further comprises identifying conflicting changes to an individual record and resolving conflicts according to a default protocol and a priority assigned to the change.

5. The method of claim 4, wherein the priority assigned to a change is according to which of the first and second synchronization databases stored the change prior to synchronization.

6. The method of claim 5, further comprising user configuration of the priority.

7. The method of claim 6, wherein user configuration of the priority comprises receiving a user selection indicating priority according to at least one of date of the change, change-originating device, and user input received during synchronizing.

8. The method of claim 4, further comprising resolving conflicting changes according to user defined protocols, wherein the default protocols are preempted by user defined protocols.

9. The method of claim 8, further comprising transferring at least one instance of user defined protocols among the portable computing device, workstation, and server prior to resolving conflicts.

10. The method of claim 1, further comprising
identifying restricted data, and
refraining from synchronizing restricted data stored within at least one of the first, second, and third databases.

11. A method for synchronizing data, the method comprising:
providing a portable computing device storing a first application instance and a portable computer device database storing data accessed by the first instance of the application;
providing a computer workstation storing a second application instance substantially identical to the first application instance and a workstation database storing data accessed by the second instance of the application;
providing a server storing a server database;
providing a network connecting the portable computing device, workstation and server;
monitoring access by the first application instance to the portable computing device database;
recording changes to the portable computing device database in a portable computing device synchronization database;
monitoring access by the second application instance to the workstation database;
recording changes to the workstation database in a workstation synchronization database; and
synchronizing the portable computing device database, workstation database, and server database according to the portable computing device synchronization database and workstation synchronization database.

12. The method of claim 11, wherein synchronizing the portable computing device database, workstation database, and server database comprises first synchronizing the portable computing device synchronization database and workstation synchronization database; second synchronizing the server synchronization database with at least one of the portable computing device synchronization database and workstation synchronization database; and third synchronizing the portable computing device synchronization database and workstation synchronization database;

13. The method of claim 12, wherein the portable computing device synchronization database contains records having first identifiers and wherein the workstation synchronization database, and server synchronization database each store records having second and third identifiers, respectively, each corresponding to one of the first identifiers, and wherein synchronizing the portable computing device synchronization database, workstation synchronization database, and server synchronization database comprises synchronizing records in the portable computing device, workstation, and server synchronization database having identical first, second, and third identifiers.

14. The method of claim 13, wherein synchronizing records further comprises identifying conflicting changes to an individual record and resolving conflicts according to a default protocol and a priority assigned to the change.

15. The method of claim 14, wherein the priority assigned to a change is according to which of the portable computing device synchronization database and workstation synchronization database stored the change prior to synchronization.

16. The method of claim 15, further comprising user configuration of the priority.

17. The method of claim 16, wherein user configuration of the priority comprises receiving a user selection indicating priority according to at least one of date of the change, change-originating device, and user input received during synchronizing.

18. The method of claim 14, further comprising resolving conflicting changes according to user defined protocols, wherein the default protocols are preempted by user defined protocols.

19. The method of claim 18, further comprising transferring at least one instance of user defined protocols among the portable computing device, workstation, and server prior to resolving conflicts.

20. The method of claim 11, further comprising
identifying restricted data, and
refraining from synchronizing restricted data stored within at least one of the portable computing device database, workstation database, and server database.

21. An article of manufacture comprising:
a computer readable medium storing a synchronization module having executable and operational data structures configured to
monitor access by a first application instance to a portable computing device database;
record changes to the portable computing device database in a portable computing device synchronization database;
synchronize the portable computing device database, workstation database, and server database according to the portable computing device synchronization database and a workstation synchronization database containing recorded changes to a workstation database, wherein the recorded changes to a workstation database made according to a second application instance substantially similar to the first application instance and a server synchronization database containing recorded changes to a server database.

22. The article of manufacture of claim 21, wherein the synchronization module is configured to first synchronize the portable computing device with the workstation synchronization database; second synchronize the portable computing device with server synchronization database; and third synchronize with the workstation synchronization database.

23. The article of manufacture of claim 21, wherein the synchronization module is configured to first synchronize the portable computing device with the server synchronization database; second synchronize the portable computing device with workstation synchronization database

24. The article of manufacture of claim 21, wherein the portable computing device synchronization database contains portable computing device records having first identifiers, the synchronization module configured to synchronize with workstation records having second identifiers and server records having third identifiers, the synchronization module synchronizing individual portable computing device records with workstation records and server records having identical second and third identifiers, respectively.

25. The article of manufacture of claim 24, wherein the synchronization module is further configured to identify conflicting records among the portable computing device records, workstation records, and server records having identical first, second, and third identifiers, respectively, the synchronization module synchronizing conflicting portable computing device records, workstation records, and server records according to a preassigned protocol and a priority assigned to each of the portable computing device records, workstation records, and server records.

26. The article of manufacture of claim 25, wherein the synchronization module is configured to assign priority according to whether the conflicting records are portable computing device records, workstation records, or server records.

27. The article of manufacture of claim 25, wherein the synchronization module is configured to determine the priority according to user input portable computing device user protocols.

28. The article of manufacture of claim 27, wherein the synchronization module is configured to receiving a user selection indicating priority according to at least one of a date of the change, type of a change-originating device, and a user input received during synchronizing.

29. The article of manufacture of claim 28, wherein the synchronization module is configured to receive workstation user protocols from the workstation, the synchronization module synchronizing conflicting records according to both the portable computing device user protocols and workstation user protocols.

30. The method of claim 21, wherein the synchronization module is configured to identifying restricted data among the portable computing device records, the synchronization module refraining from synchronizing restricted data with at least one of the workstation synchronization database and the server synchronization database.

31. A system for synchronizing data across multiple devices, the system comprising:
first and second computing devices each having a processor for processing operational and executable data structures and a memory for storing operational and executable data structures, the memory of the first and second computing devices each storing a first and a second application instances and first and second application databases, respectively, the first and second application instances being substantially identical;
a server storing a server database;
a network selectively placing the first and second computing devices and the server in data communication with each other and the server;
wherein first and second computing devices execute a client synchronization module, the synchronization module of the first and second computing devices configured to
monitor access by the first and second application instance to the first and second application databases, respectively;
record changes to the first and second databases in first and second synchronization databases, respectively;
wherein the server executing a server synchronization module configured to monitor changes to the server database and store records of changes in a server synchronization database; and
wherein the client synchronization module and server synchronization module configured to synchronizing the first and second synchronization databases and the server synchronization database.

32. The system of claim 31, wherein
the client synchronization module is configured to receive an input directing the client synchronization module to synchronize first and second synchronization databases;
at least one of the client synchronization modules of the first and second devices is configured to initiate synchronization with the server synchronization module after synchronization between the first and second device; and
the first and second client synchronization modules is configured to synchronize the first and second synchronization databases.

33. The system of claim 31, wherein
the first and second synchronization databases contain records having first and second identifiers, respectively;
the server synchronization database contains records having third identifiers, wherein each individual second and third identifier corresponding to an identical individual first identifier; and
at least one of the client synchronization module and server synchronization module is configured to synchronize each record having a first identifier with a record having an identical second identifier and a record having an identical third identifier.

34. The system of claim 33, wherein the sychnronization module is configured to identify conflicting changes between a record having a first identifier and a record having second and third identifier identical to the first identifier, the synchronization module configured to resolve conflicts according to a predetermined protocol and a priority assigned to the change.

35. The system of claim 34, wherein the priority assigned to a record is according to which of the first device, second device, and server stored the record prior to synchronization

36. The system of claim 35, wherein the first and second client synchronization modules and server synchronization module are configured to assign priority according to a user-selected priority input.

37. The system of claim 36, wherein the first and second client synchronization modules and server synchronization modules are configured to assign priority according to at least one of a date of creation of a record, a device creating the record and a user input received during synchronization.

38. The system of claim 36, wherein the first and second client synchronization modules and server synchronization modules are configured to store the user-selected priority input and to transmit the user-selected priority input during synchronization

39. The system of claim 31, wherein a portion of the records contain restricted data, the first and second client synchronization modules and server synchronization modules configured to restrict transmittal of restricted data.
